(19) United States
(12) Patent Application Publication
(10) Pub. No.: US 2006/0029459 A1
(43) Pub. Date: Feb. 9, 2006

(54) Pressure activated lubricating and cleaning instrument

(76) Inventor: Craig David Carroll, Newport Coast, CA (US)

Correspondence Address: Mr. Craig Carroll, 28 Sable Sands, Newport Coast, CA, 92657, US

(21) Appl. No.: 11/193,761

(22) Filed: Aug. 1, 2005

Related U.S. Application Data
(60) Provisional application No. 60/599,252, filed on Aug. 6, 2004.

(51) Int. Cl. B43K 5/00

(52) U.S. Cl. 401/206; 401/205

(57) ABSTRACT

This invention provides a pressure sensitive dispenser applicable to acidic and base fluids, penetrating lubricants and cleaning fluids, and capable of applying a metered drop of fluid from an applicator when the applicator is presses against a substrate. The invention includes a reservoir to store fluid, a valve system to meter the amount of fluid flow, an applicator to transfer the fluid by capillary, gravity or surface tension, and a cap to protect the applicator. The reservoir, valve system, and cap may be fabricated of materials that are impermeable to air and lubricating and cleaning fluids.

### CROSS REFERENCE TO RELATED APPLICATION

The present invention claims priority to U.S. Provisional Application for patent Ser. No. 60/599,252 filed Aug. 6, 2004 which application is incorporated herein by reference.

### BACKGROUND OF THE INVENTION

The present invention is in the field of dispensers for fluid materials such as lubricating and cleaning products, and more particularly to dispensers for products that use mineral oils and or mineral spirits, petroleum based oils, petroleum distillates, hydrocarbon fluid or organic oils, bleach or 2-Butoxyethanol, wherein the dispenser includes a valve and capillary system that meters the amount of fluid the user will apply.

The present invention relates to lubricating and cleaning products that use aerosol or compressed gas containers to lubricate and clean. The aerosol or compressed gas containers have a spray pattern used to saturate large areas. Such containers are difficult for the user to apply a metered amount of lubricant or cleaning fluid to a small centralized area.

To use a valve system dispenser with lubricating and cleaning fluids requires the use of specific components and materials to withstand the different pH levels of lubricating and cleaning fluids. The components and materials must be impermeable to outside air and vapor fluid. Current valve system applicators used for writing instruments that contain inks break down, leak and fail when exposed to lubricating fluids such as WD-40 and Liquid Wrench and cleaning fluids such as Spot Shot, Resolve Carpet Cleaner and bleach. In addition, the seals used in the current valve system applicators absorb lubricating and cleaning fluids, causing the seal to swell, breakdown and fail to function. Furthermore, lubricating fluids like WD-40 tend to penetrate into and through materials and between interference and snap fits on components causing the fluid to leak out of the dispenser. The current valve system applicators used for writing instruments such as markers and highlighters release only enough fluid to wet the writing tip when activated. Accordingly, there is a need for an improved valve and capillary dispenser that can withstand a range of pH levels without failing and apply a metered amount of lubricating and or cleaning fluid to a specific area on a substrate without over spray and messy clean up. In addition, lubricating and or cleaning fluids tend to separate and need to be mixed before applying to a substrate.

### BRIEF SUMMARY OF THE INVENTION

To solve the above mentioned problems, a pressure sensitive dispenser is provided applicable to acidic and base fluids, penetrating lubricants and cleaning fluids, and capable of applying a metered drop of fluid from an applicator when the applicator is pressed against a substrate. The present invention includes a reservoir to store the lubricating and or cleaning fluid, a valve system to meter the amount of fluid flow, an applicator to transfer the fluid by capillary, gravity or surface tension action to a substrate, and a cap to protect the applicator. The dispenser also includes, an adapter capable of supporting the applicator, a pressure sensitive seal that opens and allows fluid to be in contact with the applicator and closes to prevent excessive flow and leaking, a compression member that applies force to close the seal, and a piston capable of carrying the seal from a closed position to an open position. When the cap is removed from the dispenser, the applicator is exposed and can be placed on a substrate to be lubricated or cleaned. When pressure is applied to the applicator it is forced back into the adapter cavity, and moves the piston axially carrying the seal away from the valve cap and allowing fluid to flow past the seal and through the valve cap and in contact with the applicator. The fluid moves through the applicator by either or a combination of capillary action, gravity flow or surface tension and onto a substrate. As more pressure is applied to the applicator, more fluid flows through the applicator. As pressure is applied and released to the applicator, the piston pushes more fluid out of the applicator. As pressure is applied and released the piston moves back and forth axially and mixes the fluid.

In addition to the problem with failure of the existing seals used in valve system writing instrument designs and the amount of fluid existing writing instrument designs transfer to the writing tip, current valve system writing instrument designs use permeable materials in fabrication of the seal, valve assembly and fluid reservoir. The permeable materials allow fluid to escape through the walls of the seal, valve assembly and fluid reservoir. Accordingly, there is a need for a valve system dispenser that can seal the system when in the closed position from outside air and the loss of fluid when the dispenser is in the closed position.

The seal of the present invention may be made from a material that is compatible with lubricating and cleaning fluids. The seal may be made from a material that is durable so that the seal will not wear out after the valve assembly is cycled many times. The applicator of the present invention may be made from a material that is compatible with lubricating and cleaning fluids. The valve assembly and fluid reservoir may be made from a material that is compatible with lubricating and cleaning fluids. The valve assembly and fluid reservoir may be made from a material that reduces permeation of the lubricating and cleaning fluids. The applicator of the present invention may be made from a material that is durable so that the applicator will not wear out after the applicator is cycled many times. The seal may be treated by a secondary process know as fluorination, whereby the seal is introduced to the element fluorine to further reduce or eliminate permeation of the lubricating or cleaning fluid. The saturation ring of the present invention may be made from a material that is compatible with lubricating and cleaning fluids. The saturation ring may be made from a material that allows both air and fluid to pass through it. The cap of the present invention may be designed to have a clip, snap hook, lariat hole, brush or flat scrapper edge to assist the user in portability, removing labels and loosening unwanted materials. The dispenser of the present invention may be fabricated with two independent applicators at either end of the dispenser to allow for multiple variations in applying the lubricating or cleaning fluid. The dispenser of the present invention may be fabricated with two separate reservoirs for storing different types of lubricating and cleaning fluids.

The design is simple to manufacture and assemble enabling high volume low-cost manufacturing. These are requirements to be a competitive and saleable product in the market. In addition, the design has the enhanced feature and added value, to the end consumer, of being self metering, mess free and relatively inexpensive to manufacture, and thus purchase.

### BRIEF DESCRIPTION OF THE DRAWINGS

FIG. 1 is a cross sectional view of a fluid dispenser in the closed state showing its component parts in operative assembled relationship.

FIG. 2 is a cross sectional view of a fluid dispenser in the closed state with the cap off.

FIG. 3 is a cross sectional view of a fluid dispenser in the open state with the cap off.

FIG. 4 illustrates a dispenser that is disassembled.

FIG. 5 is a cross sectional view of a fluid dispenser in the closed state with the cap off.

FIG. 6 is a cross sectional view of a fluid dispenser in the open state with the cap off.

FIG. 7 is a cross sectional view of a fluid dispenser in the closed state with the cap off.

FIG. 8 is a cross sectional view of a fluid dispenser in the closed state with the cap off.

FIG. 9 is a cross sectional view of a fluid dispenser with two separate applicators at either end of the reservoir in the closed state.

### DETAILED DESCRIPTION OF THE INVENTION

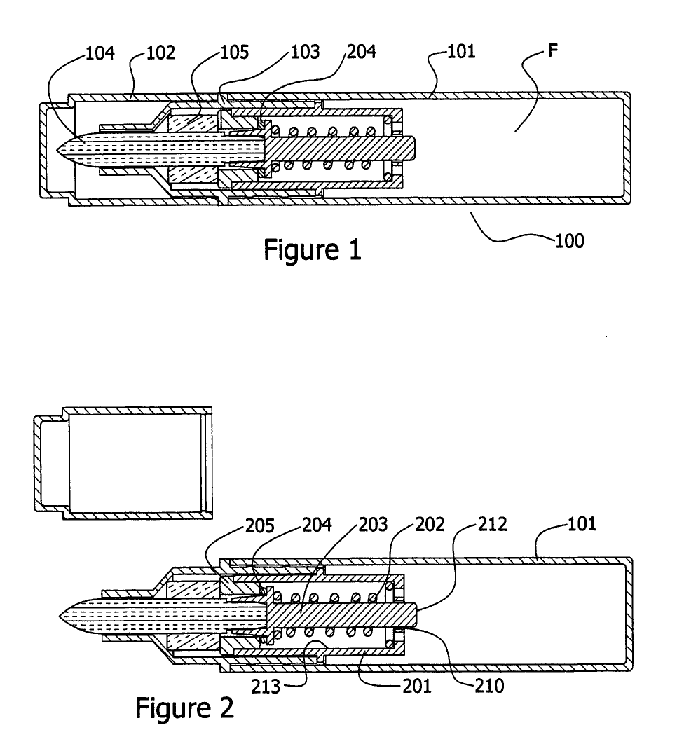

Turning to FIG. 1, there is illustrated a dispenser 100 employing an embodiment of the present invention. The dispenser 100 includes a reservoir 101 and a cap 102. The reservoir 101 is generally in the form of an elongated cylinder having a front opening to support the valve assembly 400 and a hollow body containing the lubricating and or cleaning fluid F. The reservoir 101 of the present invention can also be in the form of an oval, rectangle, or triangle. The cap 102 forms an air tight seal with the adapter 103 to prevent the evaporation of the lubricating fluid from the applicator 104 and saturation ring 105.

FIG. 2 illustrates the cross sectional view of the dispenser 100 in the closed position with the cap 102 removed. The dispenser 100 includes a valve enclosure 201 that holds a compression member 202 and guides a piston 203. The piston 203 carries a seal 204 that substantially seals the valve cap 205 and prevents the release of fluid from within the reservoir 101 when the valve assembly 400 is in the closed position. The piston 203 has a rear portion 212 that is adapted to receive the compression member 202. The valve enclosure 201 has a hole 210 that guides the elongated rear portion 212 of piston 203 along an axially direction without binding the piston 203 against the inner wall 213 of valve enclosure 201, and ensures that the seal 204 is seated properly against the valve cap 205 when in the closed position.

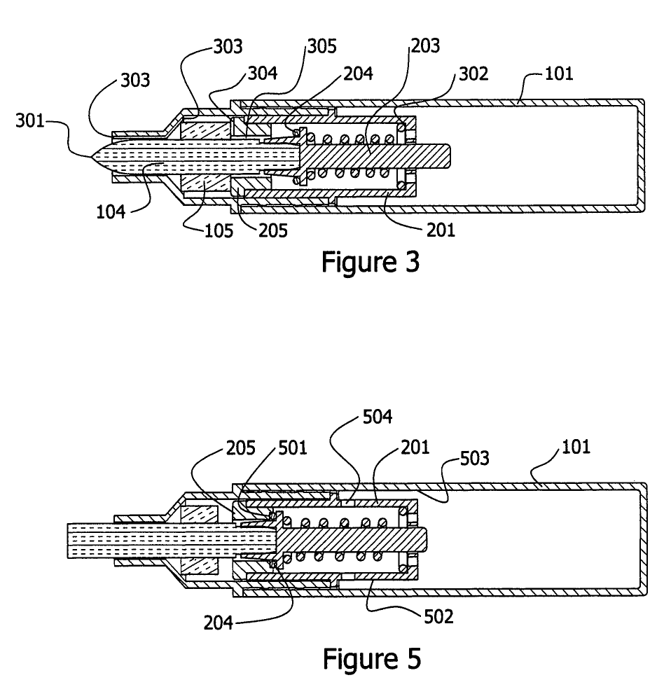

FIG. 3 illustrates the cross sectional view of the dispenser 100 in the open position. By applying pressure to the front end 301 of applicator 104, the applicator 104 moves axially through saturation ring 105, moving piston 203 to the rear portion 302 of valve enclosure 201. The piston 203 carries the seal 204 away from the valve cap 205 and allows air to enter through channel 303 and past the saturation ring 105 and through valve cap channel 304 and past valve cap opening 305 and into valve enclosure 201 and reservoir 101, allowing fluid from reservoir 101 to move through the valve cap opening 305 and come in contact with applicator 104 and saturation ring 105. The applicator 104 is adapted to store lubricating and cleaning fluid and convey the fluid to a substrate. The dispenser 100 also includes a saturation ring 105 adapted to store excess fluid that conveys through valve cap opening 305. The capillary relationship among the saturation ring 105 and applicator 104 causes the lubricating fluid to convey from the saturation ring 105 to the applicator 104. Applying more pressure to the front end 301 of applicator 104, moves the piston 203 and seal 204 closer to the rear portion 302 of valve enclosure 201, and increases the open area around the valve cap opening 305 and piston 203. The increase in open area around valve cap 305 and piston 203 allows more lubricating fluid to flow to the applicator 104 and saturation ring 105 and onto the substrate. It is required that air from the atmosphere be able to enter into the reservoir 101 in order to maintain a constant rate of fluid flow. If air from the atmosphere is not able to enter into the reservoir 101, the fluid flow rate would be significantly low. The present invention is unlike some prior art where it has been observed that, under normal operating conditions, air enters through the largest pore in the applicator 104 and or saturation ring 105. Controlling the largest pore size in applicator 104 and saturation ring 105, however, may be difficult. That is, with current manufacturing methods, the largest pore size in applicator 104 and saturation ring 105 may vary form one applicator to another and one saturation ring to another, such that one dispenser may provide excess fluid flow while another dispenser may not provide enough fluid flow. As such, each individual dispenser varies in the amount of fluid flow from the dispenser. In contrast with the present invention, the open area in channel 303 and valve cap channel 304 may be more precisely controlled in comparison to the largest pore in the applicator or saturation ring. This way, the open area in channel 303 and valve cap channel 304 may be more accurately controlled so that the performance of the dispenser 100 may be held to a tighter tolerance. In particular, if the largest pore is too large, air will easily flow into the dispenser 100 causing excess fluid to flow out of the reservoir 101. On the other hand, if the largest pore is too small, airflow into the dispenser will be restricted causing little or no fluid to flow out of reservoir 101. Thus, the channel 303 and valve cap channel 304 need to be carefully sized to have consistent performance of the fluid dispenser.

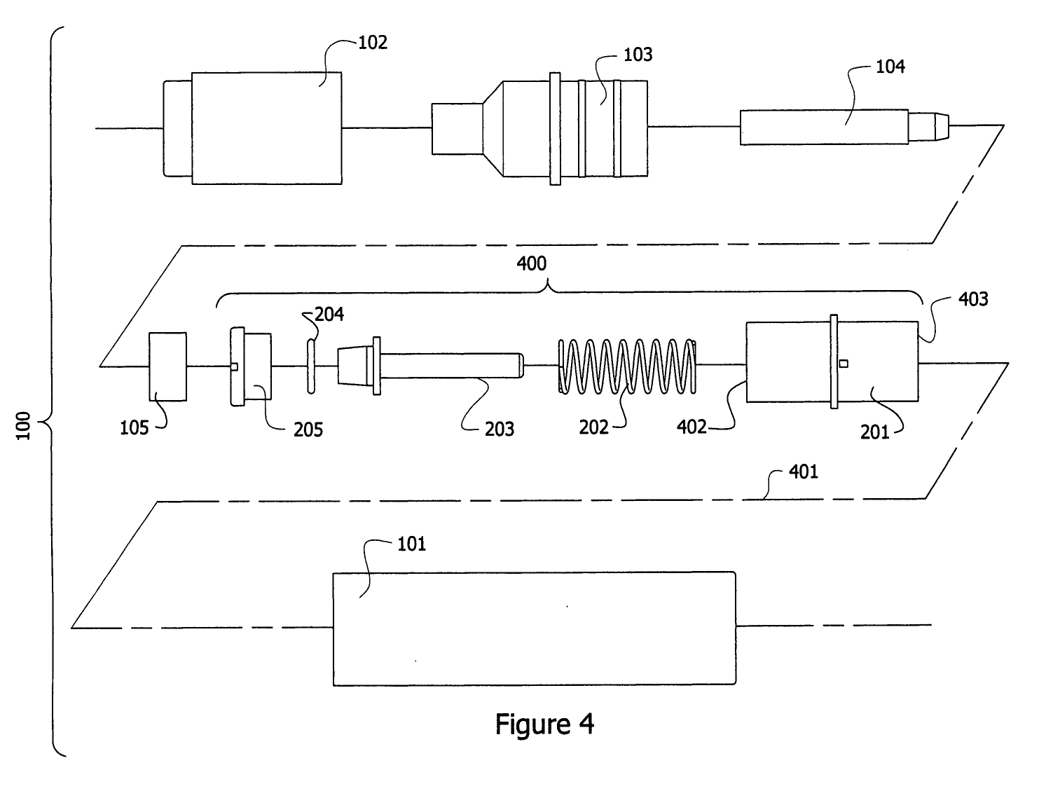

FIG. 4 illustrates the interior components of the dispenser 100. The dispenser 100 includes a cap 102 adapted to secure around the adapter 103, and a valve assembly 400 adapted to fit within the reservoir 101. The valve assembly 400 has a valve enclosure 201 that has a front end 402 and a back end 403. The valve enclosure 201 is adapted to receive the compression member 202, piston 203, seal 204, and valve cap 205 through the front end 402. The valve assembly 400 includes a piston 203 coupled to a seal 204. Compression member 202 urges the seal 204 coupled to the piston 203 in contact with valve cap 205, to substantially seal valve cap 205 from the outside air and prevent the flow of lubricating fluid from within reservoir 101, when the valve assembly is in the closed position. The valve assembly 400 is adapted to receive the applicator 104. The applicator 104 is coupled to piston 203 along a longitudinal axis 401. The applicator 104 may be removed and replaced with a new applicator 104 from the dispenser 100 when worn or damaged.

Lubricating and cleaning fluids tend to penetrate and swell plastic components used in the fabrication of valve system dispensers. It is sometimes necessary to design each component to withstand some absorption and swelling for proper fit and function in the assembly and operating of each dispenser. It has been shown in testing that some components will swell from 0 to 20% in size.

FIG. 5 illustrates the cross sectional view of the dispenser 100 in the closed position. The seal 204 is seated in the rear portion 501 of the valve cap 205. The present invention is unlike prior art where it has been observed that, under normal operating conditions, residue fluid is trapped in the dispenser between the inner wall 503 of reservoir 101 and the outer wall 502 of valve enclosure 201. The present invention provides at least one opening 504 to allow fluid to flow directly into the valve enclosure 201 without being trapped within the reservoir 101.

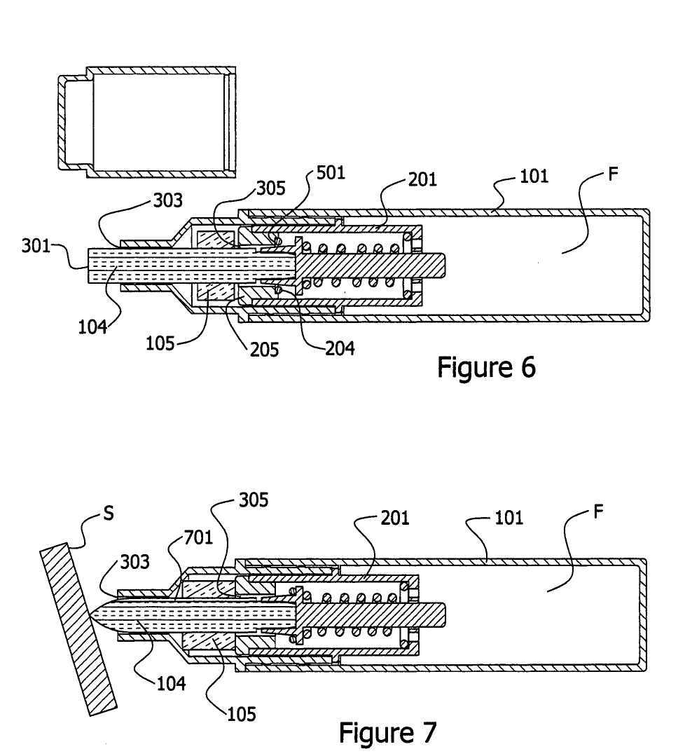

FIG. 6 illustrates the cross sectional view of the dispenser 100 in the open position. As pressure is applied to the front end 301 of applicator 104, the applicator 104 moves axially carrying saturation ring 105 and allowing air to enter through channel 303 and around saturation ring 105 and through valve cap opening 305 and into valve enclosure 201 and reservoir 101, allowing fluid from reservoir 101 to move through the valve cap opening 305 and come in contact with applicator 104 and saturation ring 105, while seal 204 remains seated in the rear portion 501 of valve cap 205.

FIG. 7 illustrates the cross sectional view of the dispenser 100 in the open position. When the applicator 104 is in contact with a substrate S onto which the fluid is to be dispensed, the force of the attraction of the substrate S and the capillary force of the space between the substrate S and portions of the applicator 104 which are not in direct contact with the substrate S will cause the fluid to flow from the applicator 104 to the substrate S. As fluid is dispensed, air enters the dispenser 100 through channels 303 and through the largest pore size in the saturation ring 105 past valve cap opening 305 and into valve enclosure 201 and reservoir 101. The air replaces the liquid so as to maintain the under pressure within the container at relatively constant level and provide fluid flow. In addition, for the dispenser 100 to provide fluid flow, fluid from reservoir 101 must enter valve enclosure 201 and must be in direct contact with applicator 104 and or saturation ring 105. The fluid flow rate can be adjusted by selection of different saturation ring 105 and applicator 104 materials with different porosity density. The saturation ring 105 in addition is able to allow air and fluid to flow through it, and functions as a buffer zone capable of absorbing extra fluid. The applicator 104 may be formed in a shape or with a groove 701 to allow more air to enter into reservoir 101 allowing more fluid to flow to the applicator 104 and saturation ring 105 and onto the substrate S.

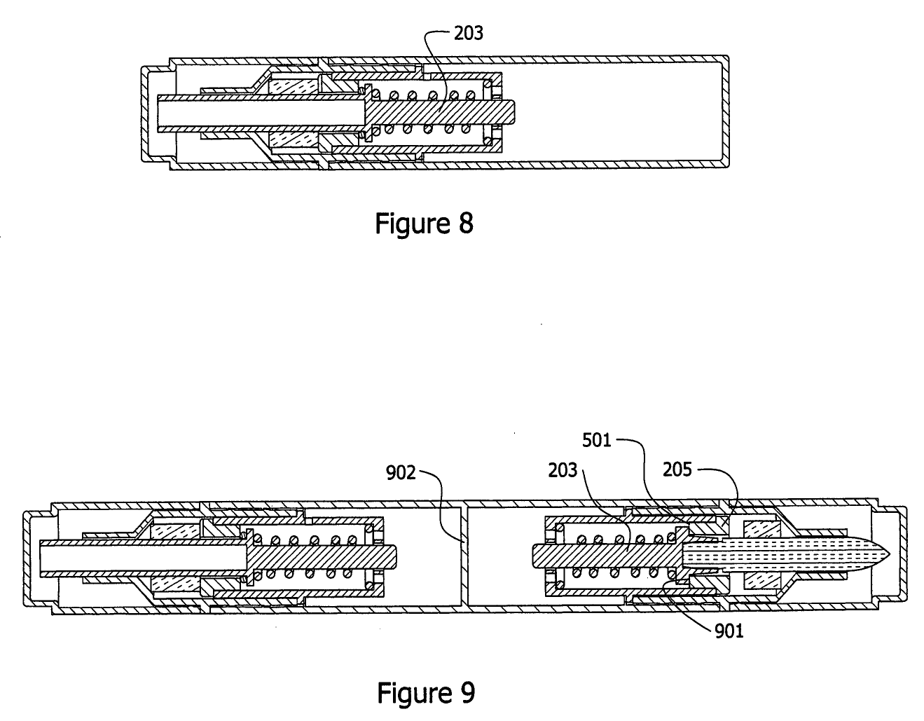

FIG. 8 illustrates the cross sectional view of the dispenser 100 in the closed position. The piston 203 and the applicator 104 may be formed into one unitary piece or two separate pieces. The piston and applicator shown in FIG. 8 may be fabricated from a dense or high porosity plastic material.

Referring again to FIG. 1, the seal 204 is shown as a flat gasket. FIG. 1 also demonstrates the saturation ring 105 as independent of the movement of the applicator 104. The saturation ring 105 can also be eliminated from the dispenser 100 to allow for direct fluid flow through the valve cap 205 to the applicator 104.

FIG. 9 illustrates the cross sectional view of a fluid dispenser with two separate applicators at either end of the reservoir in the closed position. This configuration allows for multiple variations in applicator type and fluid flow. That is, with multiple applicators, the user can choose an applicator type and fluid flow amount that best applies to the substrate they are applying fluid to. In addition, the inner wall 902 allows for different types of fluid to be stored in the reservoir 101. The reservoir 101 can be configured with or without inner wall 902. One of the applicators in FIG. 9 illustrates the piston 203 has a seal surface 901, in the closed position, the compression member 202 urges the piston 203 in contact with valve cap 205, the seal surface 901 substantially forms a seal with the rear portion 501 of valve cap 205 to substantially seal valve cap 205 from outside air and prevent the flow of fluid from within reservoir 101.

Referring again to FIG. 2, the seal 204 may be made of a material that is durable and flexible so it will not wear out after many cycles of the applicator 104. The material should have low permeability to vapor, fluid and air. The type of material used depends on the type of fluid that is used. For water based fluids with a lower evaporation rate than petroleum distillates and hydrocarbon fluid, silicone may be used to form the seal 104, but natural rubber, synthetic rubber, nitrile, butyl, and fluorocarbon elastomer are also preferred.

Referring again to FIG. 4, the cap 102, adapter 103, valve cap 205, Piston 203, valve enclosure 201, and reservoir 101 may be made of a material that is impermeable to outside air and fluid. For Petroleum based oil, hydrocarbon fluid, and petroleum distillates, acetal may be used to form the cap 102, adapter 103, valve cap 205, Piston 203, valve enclosure 201, and reservoir 101, but polypropylene is also preferred. A variety of methods may be used to form the cap 102, adapter 103, valve cap 205, Piston 203, valve enclosure 201, and reservoir 101 such as injection molding, blow molding, extrusion molding, compression molding, and other methods known to one skilled in the art. In addition, the reservoir 101 may be formed from polypropylene and covered with a heat transfer film or heat shrink film to further reduce permeation. Furthermore, the cap 102, adapter 103, valve cap 205, Piston 203, valve enclosure 201, and reservoir 101 may be formed from polypropylene, acetal, ABS, polystyrene and polyethylene and treated with fluorine to further reduce permeation.

In lubricating or cleaning of a substrate with the inventive dispenser 100, the applicator 104 is put in contact with the substrate, such as a hinge that is binding, rusted or otherwise in need of lubricating or cleaning, or a piece of fabric, tile or grout that is soiled or stained. As described above, as the user applies pressure to the applicator 104, the applicator 104 forces the piston 203 back into the valve enclosure 201 and allows air to enter into the reservoir 101 allowing fluid to flow through the valve cap opening 305 to the applicator 104 and saturation ring 105. The applicator 104 then becomes saturated with fluid and transfer the fluid to the substrate. As the user applies and releases pressure to the applicator 104, the piston 203 and seal 204 assist in forcing fluid from the valve enclosure 201 and onto the applicator 104, while mixing the lubricating fluid. The present invention is unlike some prior art where it has been observed that, under normal operating conditions, ink is transferred from the applicator tip to a writing surface. Re-absorption of the ink with the applicator tip is difficult. That is, with existing valve system applicators used for writing instruments, the ink dries too quickly. In contrast with the present invention, after applying a metered amount of fluid to a substrate, excess fluid can be redistributed to the substrate and reabsorbed into the applicator eliminating clean up mess.

It is evident from the above description that the pressure sensitive lubrication and cleaning dispenser of the present invention allows the user by means of pressure to control the amount of fluid onto the substrate and concentrate the fluid to a specific area. It is also evident from the above description that the present invention allows the user to increase the amount of fluid flow to the applicator and onto the substrate by applying more pressure to the applicator. It is also evident from the above description that the present invention allows for more precisely control in fluid flow by sizing channel 303 and valve cap channel 304 to allow air to enter into reservoir 101. It is also evident from the above description that the present invention allows the user to mix the lubricating fluid by applying and releasing pressure to the front end 301 of applicator 104. It is further evident from the above description that the present invention may be made from a material that is impermeable to outside air and lubricating and cleaning fluids. Therefore, the present invention can effectively improve the disadvantage in wasting lubrication and cleaning fluid, separation of lubrication and cleaning fluid, evaporation of lubricating and cleaning fluids, and eliminating clean up mess by over spray of the conventional inventions.

What I claim as my invention is:

1. A pressure activated lubricating and cleaning dispenser comprising:
A reservoir (101) having a hollow interior portion for storing lubricating or cleaning fluid, a valve assembly (400) for controlling the fluid, the valve assembly (400) comprising a valve enclosure (201), a compression member (202), a piston (203), a seal (204), and a seal cap (205), a saturation ring (105), a applicator (104) arranged to deflect against the resilience of a compression member (202) to control lubricating and cleaning fluid flow to the applicator (104), a adapter (103) to support the applicator (104), a piston (203) to carry the seal and for mixing the fluid, a cap (102) for protecting the applicator (104) and fluid from the air.

2. The seal (204) of claim 1, where the seal (204) is made of nitrile compound.

3. The seal (204) of claim 2, where the seal (204) includes material having a Shore A hardness of about 30 to 80.

4. The seal (204) of claim 1, where the seal (204) is made of fluorocarbon.

5. The seal (204) of claim 4, where the seal (204) includes materials having a Shore A hardness of about 30 to 80.

6. The applicator (104) of claim 1, where the applicator (104) is made of polyester.

7. The applicator (104) of claim 1, where the applicator (104) is made of acrylic.

8. The piston (203) of claim 1, where the piston (203) mixes the fluid.

9. The piston (203) of claim 1, where the piston (203) allows more fluid to flow to the applicator (104), as more pressure is applied to the front end (310) of applicator (104).

10. The seal (204) of claim 1, where the outer diameter of seal (204) determines the amount of fluid that can pass between the inner wall (213) as pressure is applied to the front end (310) of applicator (104).

11. The applicator (104) of claim 1, where the applicator (104) can be removed by the user and substituted with another applicator (104).

12. The applicator (104) of claim 1, where the applicator (104) may be fabricate in a shape with a grove (701) to allow more air to enter into the reservoir (101).

13. The piston (203) and applicator (104) of claim 1, where the piston (203) and applicator (104) may be fabricated into one unitary piece or two separate pieces.

14. The adapter (103) of claim 1, where the adapter includes channel (303) to allow for more precisely control in fluid flow.

15. The valve cap (205) of claim 1, where the valve cap (205) includes valve cap channel (304) to allow for more precisely control in fluid flow.

16. The valve enclosure (201) of claim 1, where the valve enclosure (201) includes at least one opening (504) to allow fluid to flow into valve enclosure (201).

17. The seal (204) of claim 1, where the seal (204) remains seated in the rear portion (501) of valve cap (205) when the dispenser is in the open position.

18. The saturation ring (105) of claim 1, where the saturation ring (105) allows air and fluid to flow through it and acts as a buffer zone capable of absorbing extra fluid.

19. The reservoir (101) of claim 1, where the reservoir (101) includes inner wall (902).

20. The reservoir (101) of claim 1, where the reservoir (101) is configured with at least two applicators at either end of the reservoir (101).

21. The piston (203) and valve cap (205) of claim 1, where the piston (203) has a seal surface (901) that substantially forms a seal and prevents the flow of fluid with the rear portion (501) of valve cap (205) when the dispenser is in the closed position.

22. A method according to claim 1, where the capillary storage of applicator (104) has an approximate smaller pore size and the capillary storage of saturation ring (105) has an approximate largest pore size, wherein the approximate smallest pore size of applicator (104) is smaller than the approximate largest pore size of saturation ring (105).

23. The reservoir (101) of claim 1, where the reservoir (101) is made of polypropylene.

24. The reservoir (101) of claim 23, where the reservoir (101) is covered with heat transfer film to reduce permeation.

25. The reservoir (101) of claim 23, where the reservoir (101) is covered with shrink film to reduce permeation.

26. The reservoir (101) of claim 1, where the reservoir (101) is made of acetal.

27. The reservoir (101) of claim 26, where the reservoir (101) is covered with PVC shrink film to reduce permeation.

28. The reservoir (101) of claim 26, where the reservoir (101) is covered with polyolefin shrink film to reduce permeation.

29. The reservoir (101) of claim 1, where the reservoir is treated with fluorine to reduce permeation.

30. A pressure activated lubricating and cleaning dispenser comprising:
A reservoir (101) having a hollow interior portion for storing lubricating or cleaning fluid, a valve assembly (400) for controlling the fluid, the valve assembly (400) comprising a valve enclosure (201), a compression member (202), a piston (203), and a seal cap (205), a applicator (104) arranged to deflect against the resilience of a compression member (202) to control lubricating and cleaning fluid flow to the applicator (104), a adapter (103) to support the applicator (104), a piston (203) to force fluid out of the valve enclosure (201), a cap (102) for protecting the applicator (104) and fluid from the air.

31. The piston (203) and seal cap (205) of claim 30, where the piston (203) has a seal surface (901) adapted to seal around the rear portion (501) of valve cap (205) when the dispenser is in the closed position.

32. The piston (203) of claim 30, where the piston (203) is made of acetal.

33. The piston (203) of claim 30, where the piston (203) is made of polypropylene.

34. The valve cap (205) of claim 30, where the valve cap (205) is made of acetal.

35. The valve cap (205) of claim 30, where the valve cap (205) is made of polypropylene.
